(19) United States
(12) Patent Application Publication
(10) Pub. No.: US 2009/0106820 A1
(43) Pub. Date: Apr. 23, 2009

(54) SYSTEM AND METHOD FOR USER AUTHENTICATION BASED ON ODOR RECOGNITION

(75) Inventors: Kyoung PARK, Daejeon (KR); Seung Jo BAE, Daejeon (KR); Choong Gyoo LIM, Daejeon (KR); Chang Woo YOON, Daejeon (KR); Kwang-Hyun SHIM, Daejeon (KR); Hyeon Jin KIM, Daejeon (KR); Dong Hwan SON, Daejeon (KR); Young Jik LEE, Daejeon (KR); Shin Young AHN, Dejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Electronics and Telecommunications Research Institute, Daejeon (KR)

(21) Appl. No.: 12/128,986

(22) Filed: May 29, 2008

(30) Foreign Application Priority Data
Oct. 23, 2007 (KR) 10-2007-0106376

(51) Int. Cl. H04L 9/32; G06F 15/18

(52) U.S. Cl. 726/2; 706/12

(57) ABSTRACT

A system for a user authentication includes an odor sensor unit for sensing an odor of a user's body to generate an odor biometric information vector, and a learning unit for performing an initial learning using the odor biometric information vector to generate a comparative odor biometric information vector. An authentication unit performs the user authentication by comparing an odor biometric information vector of the user's body to be authenticated from the odor sensor unit with the comparative biometric information vector if the user authentication is required. The authentication unit further performs an incremental learning of the comparative odor biometric information vector using the odor biometric information vector used in the authentication to create an incrementally learned odor biometric information vector. The comparative odor biometric information vector is updated with the incrementally learned odor biometric information vector.

### FIELD OF THE INVENTION

The present invention relates to a system and method for user authentication based on odor recognition, and more particularly, to a system and method capable of performing a user authentication by sensing unique odor biometric information of a user.

### BACKGROUND OF THE INVENTION

As electronic commerce is activated with the development of wireless networks, there arises a need for an electronic authentication system in order to ensure the security and reliability of electronic commerce using a wireless network that does not guarantee safety. The electronic authentication system is a system in which a trusted third party (a certification authority) verifies and authenticates in relation to the important certification of electronic services, including the identification function of the person concerned in related electronic services, such as electronic documents and electronic transactions in a virtual space, the information protection and integrity function of the contents of electronic services, and unmanned blocking function of electronic behaviors, and so on. The basic technology for guaranteeing the confidentiality of a private key and the integrity of a public key in a public key encryption algorithm used for this electronic signature technique is a public key-based structure.

In such a public key-based structure, a user has a digital certificate issued from a certification authority. At present, most users save such a certificate in a hard disk driver (HDD) or the like of a personal computer for its use. In this case, there are several problems or inconveniences, for example, such as the risk of hacking from outside, and the abolishment of an existing certificate and issuance of a new certificate when it is desired to use the certificate in another location. In addition, in case a certificate is saved in a floppy disk, the mobility problem is solved but there is a risk of loss or duplication, and a durability problem such as damage occurs.

Further, in the existing public key-based structure, a user should use a password in order to adopt an encrypted private key. In this case, there is the likelihood that the user may forget the password, which has a risk that the password may be exposed to others.

To overcome these problems, a variety of techniques for user authentication using unique biometric information of a human body have been proposed. For example, these techniques may include a technique of executing authentication using biometric information inputted by a user and updating the standard biometric information, a technique of saving user biometric authentication information in an authentication server and database on the Internet/Intranet and executing authentication, and a technique of providing biometric authentication with excellent security by executing two stages of biometric information authentication.

More specifically, in the technique of updating biometric authentication, the authentication or recognition of a user is executed basically by using the biometric information inputted by the user. If there is provided new biometric information matching with prestored comparative biometric information within a predetermined range, the new biometric information is registered and utilized as the comparative biometric information.

In this technique, the prestored comparative biometric information of the user is updated based on the number or a matching value (e.g., Euclidean distance) of the feature points in the biometric information, so that the authentication or recognition process can be executed rapidly, and the comparative biometric information is always updated with latest information, thus increasing the recognition rate. Especially, in case this technique is used for a general biometric recognition device, such as a fingerprint recognition device and a face recognition device, several sets of candidate biometric information (to be compared) are stored for a single fingerprint or face.

In the technique of storing user biometric authentication information in an authentication server and database in advance and executing authentication, personal biometric information is used for user authentication under the Internet/Intranet environment. In this technique, by storing user biometric information in a biometric information database, transferring the user biometric information over the Internet/Intranet and comparing the biometric information, it is possible to recognize the user, update the user's biometric information, manage the authentication status, and search for authentication-related information through the web. Accordingly, for users of electronic commerce, damage caused by the leakage of personal information is minimized to thereby solve the distrust in electronic commerce, and for companies and financial institutions employing electronic commerce, a more stable electronic commerce environment is provided to encourage the spread of electronic commerce.

The technique of providing biometric authentication with excellent security by executing two stages of biometric information authentication offers user authentication with high security by using two terminals. This technique proposes a biometric authentication system comprising a first terminal (e.g., a reception terminal or a pre-authentication terminal) for conducting user authentication and a second terminal (e.g., a window terminal or a transaction terminal) for conducting service transactions by permitting the operation of a user based on the result of authentication of the first terminal.

The first terminal includes a first biometric information reading unit for reading certain biometric information, a reading and writing unit for conducting reading from and writing on a recording medium, and a first control unit for combining the biometric information read from the first biometric information reading unit with the biometric information read from the reading and writing unit (first authentication).

The second terminal includes a second biometric information reading unit for reading another biometric information different from the biometric information, a reading and writing unit for conducting reading from and writing on the recording medium, and a second control unit for combining the another biometric information read from the second biometric information reading unit with the biometric information read from the medium reading and writing unit (second authentication). As mentioned above, the existing techniques for user authentication using unique biometric information of a human body can solve the problems, like the inconvenience of having a certificate issued, the risk of loss and duplication of a certificate, and the risk of password exposure that occur in the existing electronic authentication system.

However, among the conventional techniques for user authentication using unique biometric information of a human body, in the technique of updating biometric information, the biometric information of the human body is not always consistently provided to the system, and the biometric information is also affected by various surrounding environments, which in turn affects the authentication rate or recognition rate in the system. In addition, the biometric information may change gradually with time due to aging. Hence, the biometric information have to be reregistered unless latest biometric information is updated, thereby causing any inconvenience to the users.

Further, in the technique of storing user biometric authentication information in an authentication server and database in advance and executing authentication, there is a problem that the security of authentication is low because authentication is performed through the network and the web.

Moreover, in the technique of providing biometric authentication with excellent security by executing two stages of biometric information authentication, user authentication with high security can be executed by using two terminals. However, if there exists a plurality of second terminals, the biometric authentication has to be conducted commonly by the first terminal, thus causing any inconvenience in use, including having to make contact with a sensor of an authentication system or issue a voice at the time point when authentication is required.

### SUMMARY OF THE INVENTION

It is, therefore, a primary object of the present invention to provide a system and method for user authentication based on odor recognition.

It is another object of the present invention to provide a system and method for user authentication based on odor recognition with a capability of updating comparative odor biometric information through incremental learning.

In accordance with an aspect of the present invention, there is provided a system for a user authentication based on odor recognition, including:

an odor sensor unit for sensing an odor of a user's body to generate an odor biometric information vector;

a learning unit for performing an initial learning using the odor biometric information vector to generate a comparative odor biometric information vector; and

an authentication unit for performing the user authentication by comparing an odor biometric information vector of the user's body to be authenticated from the odor sensor unit with the comparative biometric information vector if the user authentication is required.

In accordance with another aspect of the present invention, there is provided a method for a user authentication based on odor recognition, including the steps of:

(a) sensing an odor of a user's body to generate an odor biometric information vector;

(b) performing an initial learning using the odor biometric information vector to generate a comparative odor biometric information vector;

(c) performing user authentication by comparing an odor biometric information vector of a user to be authenticated with the comparative odor biometric information vector if the user authentication is required; and

(d) performing an incremental learning using the comparative odor biometric information vector and the odor biometric information vector used in the user authentication to update the comparative odor biometric information with an incrementally learned odor biometric information vector through the incremental learning.

### BRIEF DESCRIPTION OF THE DRAWINGS

The above and other objects and features of the present invention will become apparent from the following description of preferred embodiments, given in conjunction with the accompanying drawings, in which:

FIG. 1 illustrates a block diagram of a system for user authentication based on odor recognition in accordance with an embodiment of the present invention;

FIG. 2 presents a detailed block diagram of the odor sensor unit shown in FIG. 1;

FIG. 3 shows a flowchart for explaining an initial learning process of a method for user authentication based on odor recognition in accordance with an embodiment of the present invention; and

FIG. 4 provides a flowchart for explaining an authentication and incremental learning process of a method for user authentication based on odor recognition in accordance with an embodiment of the present invention.

### DETAILED DESCRIPTION OF THE EMBODIMENT

Hereinafter, the operational principle of the present invention will be described in detail with reference to the accompanying drawings. As fully discussed below, the key feature of the present invention is that unique comparative odor biometric information of a user is learned by sensing unique odor biometric information of the user's body, and the user is authenticated based on the learned comparative odor biometric information.

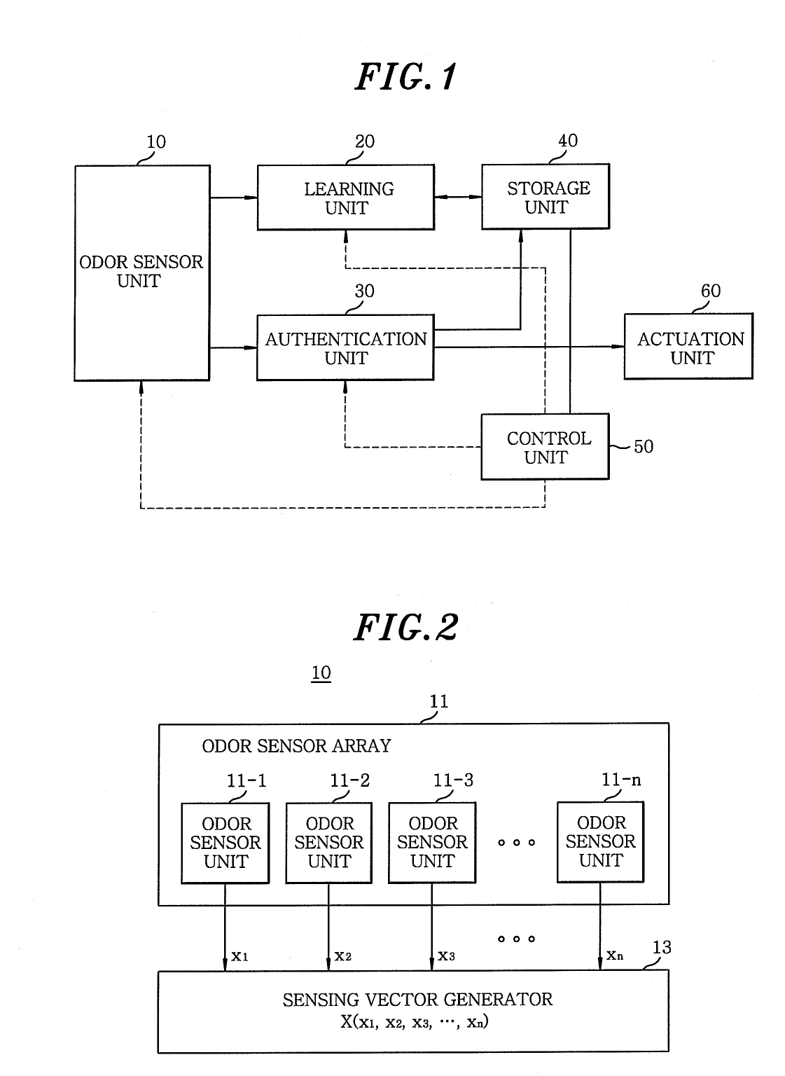

FIG. 1 illustrates a block diagram of a system for user authentication based on odor recognition in accordance with an embodiment of the present invention; and FIG. 2 presents a detailed block diagram of the odor sensor unit shown in FIG. 1.

The system of the present invention includes an odor sensor unit 10 for sensing a unique odor for a human body at an initial stage to generate odor biometric information for comparison, a learning unit 20 for learning the odor biometric information, an authentication unit 30 for authenticating a user by using the odor biometric information learned by the learning unit 20 and performing an incremental learning, a storage unit 40 for storing the odor biometric information, a control unit 50 for controlling the sensing, learning and authentication operations, and an actuation unit 60 for offering a desired service upon completion of the authentication.

As depicted in detail in FIG. 2, the odor sensor unit 10 is provided with an odor sensor array 11 and a sensing vector generator 13. The odor sensor array 11 has a plurality of odor sensors 11-1, . . . , 11-n for identifying the odor of the human body. The odor sensors 11-1, . . . , 11-n senses the odor of the human body upon receipt of a request for sensing odor biometric information from the control unit 50 at an initial stage to produce odor biometric information x₁, x₂, . . . xₙ, respectively.

In accordance with the present invention, the sensing of the odor is repeatedly carried out until comparative odor biometric information is sufficiently acquired, wherein the number of sensing times is referred to as a maximum number of learning times which will be described below. The odor biometric information x₁, x₂, . . . , xₙ acquired by the odor sensors 11-1, . . . , 11-n of the odor sensor array 11 is then provided to the sensing vector generator 13 for each sensing time. The sensing vector generator 13 generates a odor biometric information vector X(X₁, X₂, . . . , xₙ) from the odor biometric information provided from the odor sensor array 11. The odor biometric information vector X generated by the sensing vector generator 13 is then delivered to each of the learning unit 20 and the authentication unit 30 as odor biometric information vector X.

The learning unit 20, in response to an initial learning request from the control unit 50, reads the number α of learning times and a comparative odor biometric information vector V to be referred at the time of user authentication, from the storage unit 40. Here, the initial value of the vector V is ‘0’, and the initial value of α is set to ‘0’. The learning unit 20 performs an initial learning based on the comparative odor biometric information vector V and the odor biometric information vector X to obtain a learned odor biometric information vector V′. The number α of learning times increments by ‘1’ from the initial value ‘0’, i.e., α=α+1, whenever learning is performed. This initial learning process is repeated until the maximum number of learning times is reached. The learned odor biometric information vector V′ is calculated by an averaging method as follows:

V′=(1−α⁻¹)*V+α⁻¹*X Eq. (1)

The learned odor biometric information vector V′ is repeatedly updated with the comparative odor biometric information vector V which is then stored in the storage unit 40. When the initial learning is performed enough to conduct the user authentication as the maximum number of learning times is reached, the initial learning is then finished, and the comparative odor biometric information is finally obtained.

The authentication unit 30 reads the comparative odor biometric information vector V and a learning coefficient β from the storage unit 40 upon receipt of a request for authentication and incremental learning from the control unit 50. In addition, the authentication unit 30 reads the odor biometric information vector X provided from the odor sensor unit 10, and then calculates a distance or an absolute value ‘d’ of a difference vector between the comparative odor biometric information vector V and the odor biometric information vector X as follows:

d=|X−V| Eq. (2)

The authentication unit 30 compares the absolute value ‘d’ of the difference vector calculated by Eq. (2) with an authentication threshold value for user authentication. For example, the authentication threshold value may be set to a value capable of effectively identifying a user. As a result of comparison, if the absolute value ‘d’ of the difference vector is less than the authentication threshold value, the authentication unit 30 decides authentication based on odor biometric information to be successful and notifies the activation unit 60 of an authentication success, followed by performing the incremental learning to be explained later. On the other hand, if the absolute value ‘d’ of the difference vector is not less than the authentication threshold value, the authentication unit 30 decides authentication based on odor biometric information to have failed. If the authentication fails, the authentication unit 30 performs a separate authentication process, for example, using a password, fingerprint, voice, etc. If authentication succeeds through such a separate authentication procedure, the authentication unit 30 notifies the activation unit 60 of an authentication success, and carries out the incremental learning. However, if the authentication fails even in the separate authentication procedure, the authentication unit 30 notifies the activation unit 60 of an authentication failure.

What the authentication based on odor recognition or authentication based on a password, fingerprint, and voice is successful means that the user is verified. Therefore, the authentication unit 30 updates the comparative odor biometric information vector V through incremental learning. However, the odor of the user may substantially change with the passage of time or depending on environments, and the incremental learning is for adaptation to such a change. Therefore, the authentication unit 30 updates the comparative odor biometric information with changed odor biometric information of the user obtained through the incremental learning. An odor biometric information vector being subjected to the incremental learning can be calculated by:

V″=(1−β)*V+β*X Eq. (3)

wherein V″ indicates an incrementally learned odor biometric information vector, and β denotes a learning coefficient for incremental learning, which is a value adaptable to a change in the user's body odor.

The incrementally learned odor biometric information vector V″ is upgraded as the comparative odor biometric information vector V, and stored in the storage unit 40.

The storage unit 40 stores the comparative odor biometric information vector learned by the learning unit 20 and the number α of learning times, and the comparative odor biometric information vector which is incrementally learned by the authentication unit 30.

The control unit 50 requests the odor sensor unit 10 to sense the odor biometric information, and requests the learning unit 20 to learn the same in order to obtain the comparative odor biometric information for user authentication at an initial stage. Then, when the initial learning enough for user authentication is performed, the control unit 50 controls that the initial learning is not performed any further. Further, the control unit 50 requests the authentication unit 30 for the incremental learning so as to be adapted to a change in the user's body odor after the authentication.

Although the above-described embodiment of the present invention suggests a manner for obtaining the comparative odor biometric information by repeatedly averaging the odor biometric information, it may also be possible to obtain the comparative odor biometric information by storing sufficiently many odor samples in the storage unit 40 and averaging them at a time.

The operation unit 60 normally performs various electronic commerce transactions in response to the authentication success notified from the authentication unit 30, while it finishes various electronic commerce operations being performed in response to the authentication failure notified from the authentication unit 30.

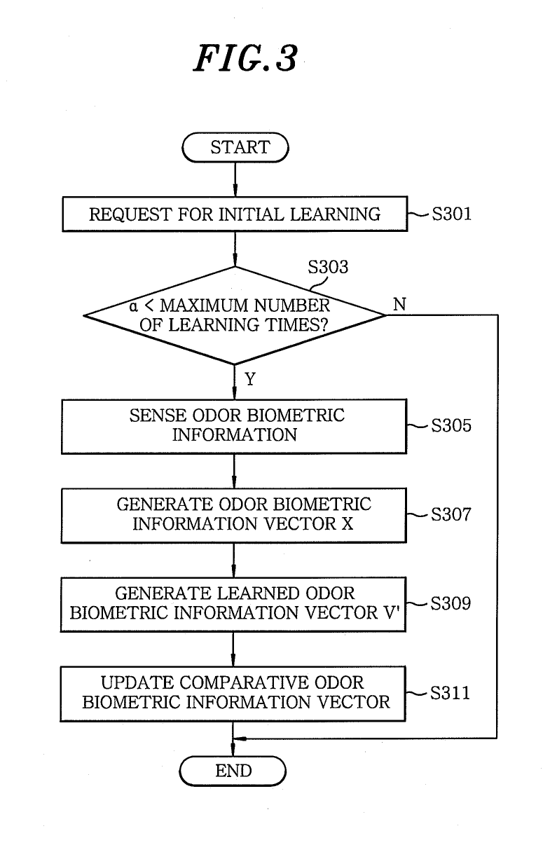

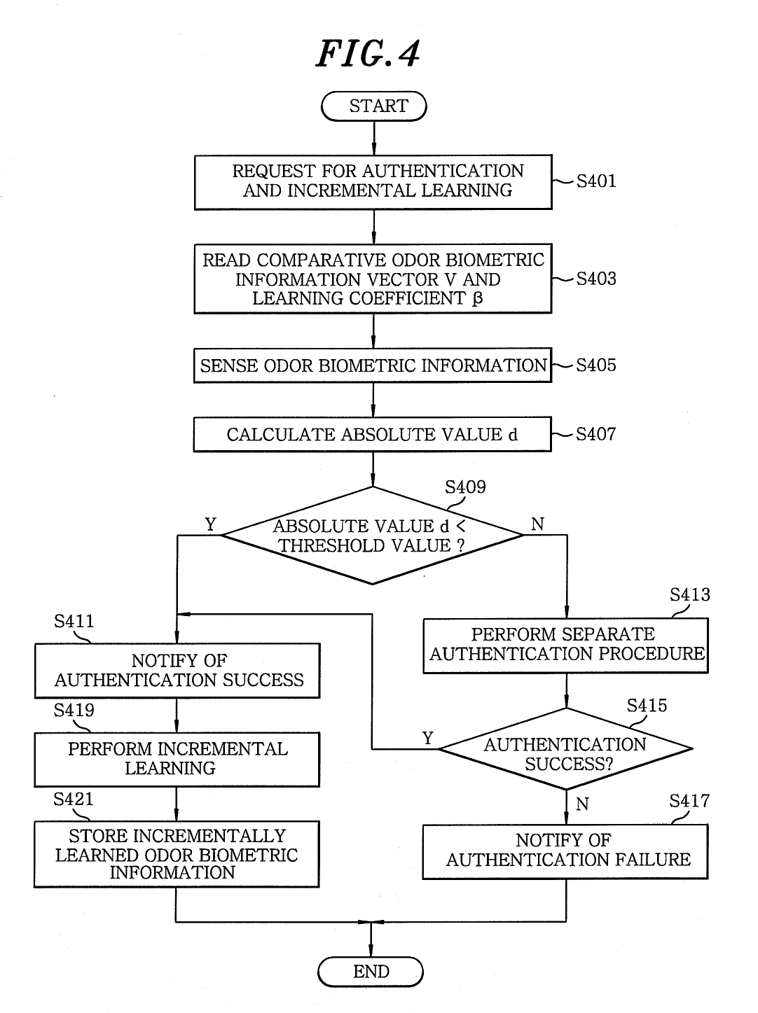

Now, a method for user authentication based on odor recognition in accordance with an embodiment of the present invention will be described in detail with reference to FIGS. 3 and 4.

FIG. 3 shows a flowchart illustrating an initial learning process of a method for user authentication based on odor recognition in accordance with the present invention.

First of all, at step S301, the control unit 50 requests the learning unit 20 for an initial learning so that the learning unit 20 reads a comparative odor biometric information vector V, if any, and the number α of learning times from the storage unit 40.

At step S303, it is determined that the number α of learning times reaches a preset maximum number of learning times. If negative, the initial learning is completed; otherwise, the initial learning is performed as follows. This initial learning is repeated by incrementing the number α of learning times by ‘1’ until it reaches a predetermined maximum number of learning times while updating the comparative odor biometric information vector V with the learned odor biometric information vector V′. That is, at step S305, the odor sensor array 11 senses an odor of a user's body to acquire odor biometric information x₁, x₂, . . . , xₙ. The odor biometric information acquired by the odor sensors 11-1, . . . , 11-n is then provided to the sensing vector generator 13.

At step S307, the sensing vector generator 13 then produces a odor biometric information vector X for the odor biometric information x₁, x₂, . . . , xₙ provided from the odor sensor array 11.

Thereafter, at step S309, the learning unit 20 performs the initial learning using the odor biometric information vector X and the comparative odor biometric information vector V to generate a learned odor biometric information vector V′, as expressed in Equation. 1, while incrementing the number α of learning times by ‘1’.

Nest step S311, the comparative odor biometric information vector V is updated with the learned odor biometric information vector V′, and then stored in the memory unit 40.

FIG. 4 provides a flowchart illustrating an authentication and incremental learning process of a method for user authentication based on odor recognition in accordance with the present invention.

First of all, at step S401, the control unit 50 requests the authentication unit 30 for user authentication and incremental learning based on odor recognition.

Then, at step S403, the authentication unit 30 reads the comparative odor biometric information vector V and a learning coefficient β prestored in the storage unit 40 upon receipt of the authentication and incremental learning request.

In addition, at step S405, the odor sensor unit 10 senses an odor of a user to be authenticated to generate an odor biometric information vector X therefor. The odor biometric information vector X is then provided to the authentication unit 30.

Next, at step S407, an absolute value ‘d’ of a difference vector between the odor biometric information vector X and the comparative odor biometric information vector V is calculated.

Subsequently, at step S409, the absolute value ‘d’ of the difference vector is compared with an authentication threshold value for user authentication.

As a result of comparison at step S409, if the absolute value ‘d’ of the difference vector is less than the authentication threshold value, the process of the present invention proceeds to step S411 to notify the operation unit 60 of an authentication success.

On the other hand, as a result of comparison at step S409, if the absolute value ‘d’ of the difference vector is not less than the authentication threshold value, which decides the user authentication based on odor recognition to have failed. Accordingly, the process goes to step S413 where performing a separate authentication procedure based on password/fingerprint/voice.

At a next step S415, it is checked whether the separate authentication procedure based on password/fingerprint/voice is successful or not.

Meanwhile, as a result of checking at step S415, if the separate authentication procedure also fails, the process advances to the step S417 which notifies the operation unit 60 of an authentication failure, and this process is finished.

However, as a result of checking at step S415, if the separate authentication procedure is successful at step S411, the process goes to step S411 which notifies the operation unit 60 of an authentication success. Therefore, if the authentication based on odor recognition or the authentication based on a password, fingerprint, and voice is successful, this means that the user is verified.

Accordingly, the process proceeds to step S419 where an incremental learning is performed using the odor biometric information vector X used in authentication and the comparative odor biometric information vector X to create an incrementally learned odor biometric information vector V″.

At a next step S421, the incrementally learned odor biometric information vector V″ is upgraded as the comparative odor biometric information vector V, and stored in the storage unit 40, and this process is finished.

As a result, a user can be authenticated by sensing unique odor biometric information of the user's body. Moreover, it is possible to adapt to a change in odor biometric information with the passage of time by updating comparative odor biometric information learned through incremental learning each time user authentication is performed.

While the invention has been shown and described with respect to the preferred embodiments, it will be understood by those skilled in the art that various changes and modification may be made without departing from the spirit and scope of the invention as defined in the following claims.

What is claimed is:

1. A system for a user authentication based on odor recognition, comprising:
an odor sensor unit for sensing an odor of a user's body to generate an odor biometric information vector;
a learning unit for performing an initial learning using the odor biometric information vector to generate a comparative odor biometric information vector; and
an authentication unit for performing the user authentication by comparing a odor biometric information vector of the user's body to be authenticated from the odor sensor unit with the comparative biometric information vector if the user authentication is required.

2. The system of claim 1, wherein the odor sensor unit includes:
an odor sensor array having a plurality of odor sensors, each sensing the odor of the user's body to generate odor biometric information; and
a sensing vector generator for generating the odor biometric information vector X from the odor biometric information from the odor sensor array.

3. The system of claim 1, further comprising:
a control unit for requesting the learning unit for the initial learning so that the odor sensor unit senses the odor to produce the odor biometric information, and requesting the authentication unit for the user authentication based on odor recognition and the incremental learning at an initial stage; and
a storage unit for updating the comparative odor biometric information vector with the learned odor biometric information vector generated by the learning unit for its storage therein, and updating the comparative odor biometric information used in the user authentication with the odor biometric information vector incrementally learned by the authentication unit for its storage therein.

4. The system of claim 1, wherein the learning unit generates learned odor biometric information by averaging the comparative odor biometric information vector from the storage unit and the odor biometric information vector from the odor sensor unit, and wherein the comparative odor biometric information vector is updated with the learned odor biometric information vector.

5. The system of claim 1, wherein the authentication unit further performs an incremental learning the comparative odor biometric information vector using the odor biometric information vector used in the authentication to create an incrementally learned odor biometric information vector, wherein the comparative odor biometric information vector is updated with the incrementally learned odor biometric information vector.

6. The system of claim 4, wherein the learned odor biometric information vector V′ is calculated by:
V′=(1−α¹)*V+α⁻¹*X
wherein α denotes a predetermined number of learning times, V denotes the comparative odor biometric information vector, and X denotes the odor biometric information vector.

7. The system of claim 4, wherein the authentication unit authenticates the user by calculating a distance between the comparative odor biometric information vector and the odor biometric information vector, and comparing the calculated distance with a predetermined authentication threshold value.

8. The system of claim 7, wherein the distance d is obtained as follows:
d=|X−V|

wherein X indicates the odor biometric information vector, and V denotes the comparative odor biometric information vector.

9. The system of claim 1, wherein, if the authentication based on odor recognition fails, the authentication unit authenticates the user by performing an authentication process based on password, fingerprint, or voice.

10. The system of claim 1, wherein the incrementally learned odor biometric information vector is calculated by:
V″=(1−β)*V+β*X
wherein V represents the comparative odor biometric information vector and β denotes a learning coefficient.

11. The system of claim 9, wherein the incrementally learned odor biometric information vector is upgraded with the comparative odor biometric information vector.

12. A method for a user authentication based on odor recognition, comprising the steps of:
(a) sensing an odor of a user's body to generate an odor biometric information vector;
(b) performing an initial learning using the odor biometric information vector to generate a comparative odor biometric information vector;
(c) performing user authentication by comparing an odor biometric information vector of a user to be authenticated with the comparative odor biometric information vector if the user authentication is required; and
(d) performing an incremental learning using the comparative odor biometric information vector and the odor biometric information vector used in the user authentication to update the comparative odor biometric information with an incrementally learned odor biometric information vector through the incremental learning.

13. The method of claim 12, wherein the step (b) of performing an initial learning includes the steps of:
(b1) averaging the comparative odor biometric information vector and the odor biometric information to generate a learned odor biometric information vector;
(b2) updating the comparative odor biometric information vector with the learned odor biometric information vector; and
(b3) repeatedly performing the steps (a) to (b2) until the number of the learning is reached to a preset of learning times.

14. The method of claim 12, wherein the step (c) of performing user authentication includes the steps of:
(c1) calculating the distance between the odor biometric information vector and the comparative odor biometric information vector; and
(c2) comparing the distance with a preset authentication threshold value thereby authenticating the user.

15. The method of claim 14, further comprising the step of performing a separate authentication process if the authentication fails.
